(19) United States
(12) Patent Application Publication
(10) Pub. No.: US 2011/0050928 A1
(43) Pub. Date: Mar. 3, 2011

(54) SELECTION SYSTEM AND METHOD FOR CAMERA

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/580,270

(22) Filed: Oct. 16, 2009

(30) Foreign Application Priority Data
Aug. 27, 2009 (CN) 200910306181.X

(51) Int. Cl. H04N 5/225

(52) U.S. Cl. 348/218.1; 348/E05.024

(57) ABSTRACT

A selection system includes a sensor, a processing unit, and a driving unit. The sensor is mounted on an electronic device to measure changes in position of the electronic device and output measurement results correspondingly. The processing unit receives the measurement results to obtain an angle of inclination of the electronic device relative to a datum plane, outputs an angle control signal according to the angle of inclination, and selects one of a number of cameras according to the angle control signal. The electronic device displays images captured by the selected camera.

### BACKGROUND

1. Technical Field

The present disclosure relates to a selection system and a selection method for cameras.

2. Description of Related Art

Conventional media players cannot customize the display of media in response to input, such as different visual angles. Many commonly used media players are non-interactive, thus reducing the level of user satisfaction.

### BRIEF DESCRIPTION OF THE DRAWINGS

FIG. 1 is a schematic block diagram of a first exemplary embodiment of a selection system including a storage system.

FIG. 2 is a schematic block diagram of the storage system of FIG. 1.

FIGS. 3A-3C are schematic diagrams of an electronic device in three states.

FIG. 4 is a schematic diagram of images captured by a camera according to the electronic device in FIGS. 3A-3C, respectively.

FIG. 5 is a schematic diagram of the images displayed by the electronic device in FIGS. 3A-3C, respectively.

FIG. 6 is a schematic block diagram of a second exemplary embodiment of a selection system including a storage system.

FIG. 7 is a schematic block diagram of the storage system of FIG. 6.

FIG. 8 is a flowchart of a first embodiment of a selection method.

FIG. 9 is a flowchart of a second embodiment of a selection method.

### DETAILED DESCRIPTION

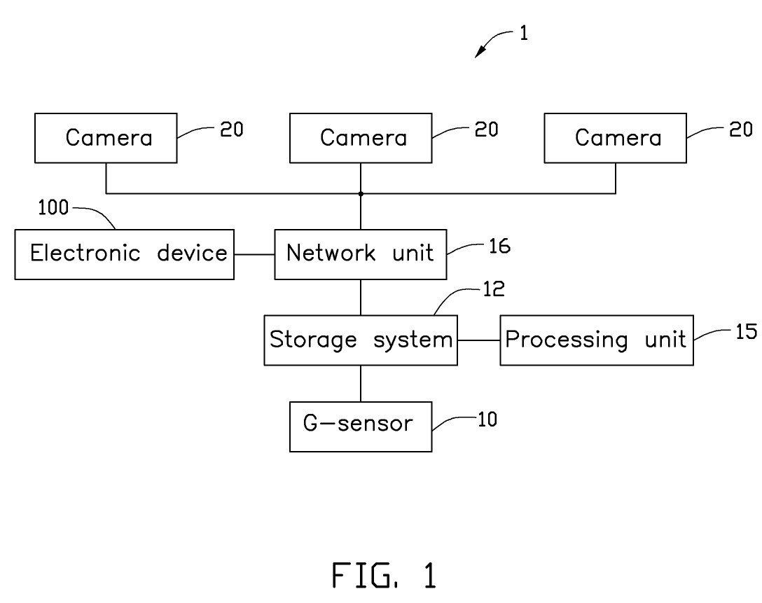

Referring to FIG. 1, a first embodiment of a selection system 1 includes a G-sensor 10, a storage system 12, a processing unit 15, a network unit 16, and a plurality of cameras 20. The selection system 1 is operable to select one of the cameras 20 according to the state of an electronic device 100. The electronic device 100 displays images captured by the selected camera 20.

The G-sensor 10 is mounted on the electronic device 100 and detects motion of the device.

The plurality of cameras 20 forms an array camera system. In the array camera system, the plurality of cameras 20 is arranged in circularity, or on a curved surface. The plurality of cameras 20 align with or opposite to an object to be monitored. The array camera system shoots the object from multi-angles at a same time to obtain composite images, or shoots environment around the object from multi-angles at a same time to obtain composite images.

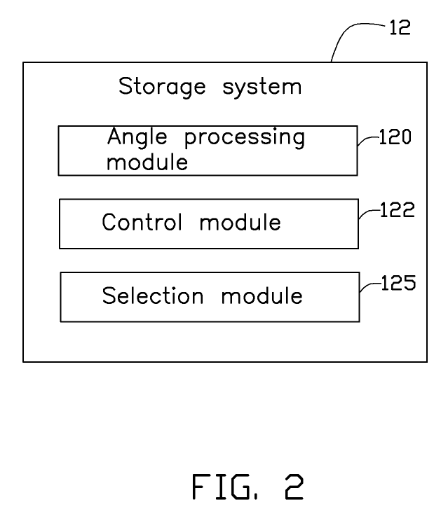

Referring to FIG. 2, the storage system 12 includes an angle processing module 120, a control module 122, and a selection module 125. The angle processing module 120, the control module 122, and the selection module 125 may include one or more computerized instructions and are executed by the processing unit 15.

The angle processing module 120 receives input from the G-sensor 10 and obtains an angle of inclination of the electronic device 100 relative to a datum plane. It can be understood that the angle processing module 120 calculates and compares voltages of the G-sensor 10 corresponding to the position of the electronic device 100 relative to the datum plane to obtain the angle of inclination of the electronic device 100 relative to the datum plane.

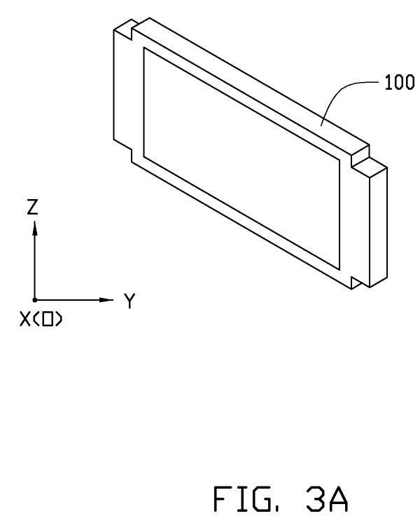

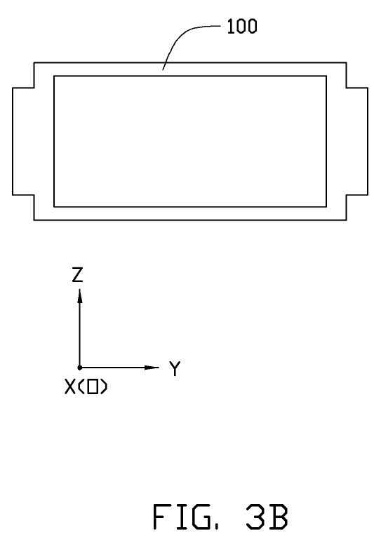

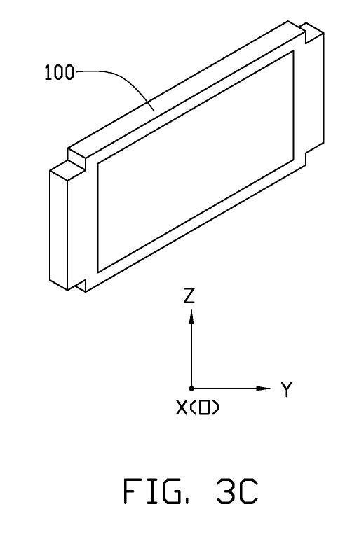

Referring to FIGS. 3A-3C, an angle of 135° is between the electronic device 100 in a first state and a datum plane YOZ shown in FIG. 3A. An angle of 0° is between the electronic device 100 in a second state and the datum plane YOZ shown in FIG. 3B. An angle of 45° is between the electronic device 100 in a third state and the datum plane YOZ shown in FIG. 3C.

The control module 122 receives the angle of inclination of the electronic device 100 relative to the datum plane from the angle processing module 120, and outputs an angle control signal correspondingly. For example, if the angle between the electronic device 100 in the first state and the datum plane YOZ is 135°, the control module 122 outputs a first angle control signal. If the angle between the electronic device 100 in the second state and the datum plane YOZ is 0°, the control module 122 outputs a second angle control signal. If the angle between the electronic device 100 in the third state and the datum plane YOZ is 45°, the control module 122 outputs a third angle control signal.

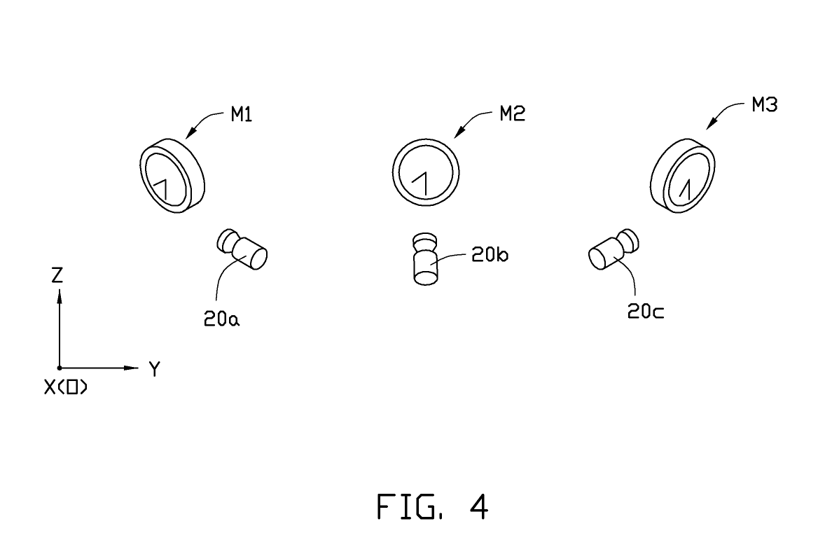

The selection module 125 selects one of the plurality of cameras 20 according to the angle control signal. For example, if the control module 122 outputs the third angle control signal, the selection module 125 selects the camera 20c. The camera 20c captures the image M3, as shown in FIG. 4. In FIG. 4, the camera 20a captures the image M1, and the camera 20b captures the image M2.

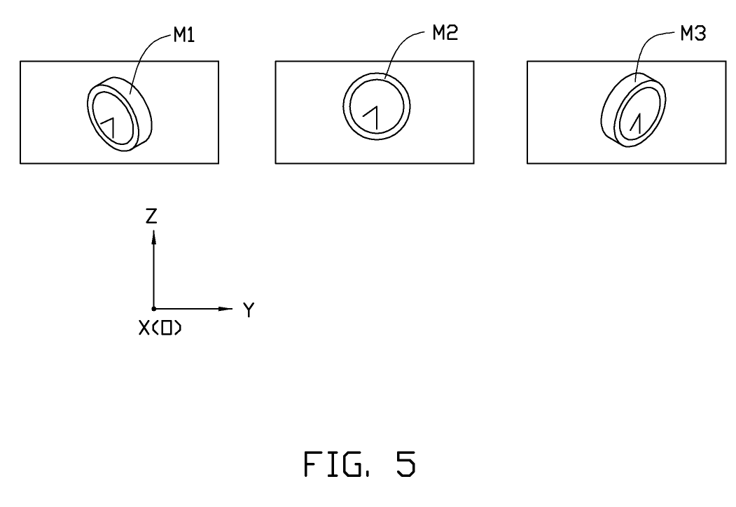

The selection module 125 also transmits the images captured by the selected camera 20a, 20b, or 20c to the electronic device 100 via the network unit 16. The electronic device 100 displays the images as shown in FIG. 5. It can be understood that the network unit 16 may include communication tools, such as a router, to enable the storage system 12 to communicate with the electronic device 100.

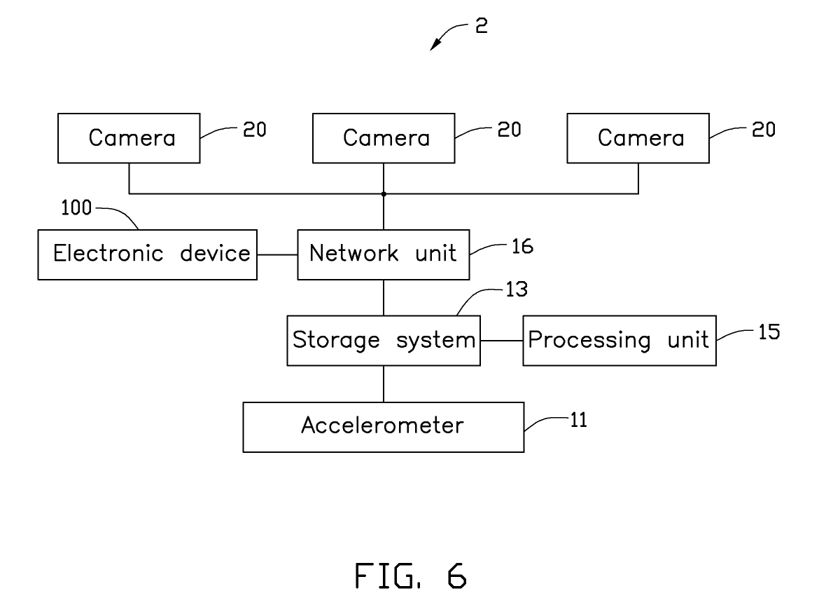

Referring to FIG. 6, a second embodiment of a selection system 2 includes an accelerometer 11, a storage system 13, a processing unit 15, a network unit 16, and a plurality of cameras 20.

The accelerometer 11 is mounted on the electronic device 100 and provides measurement of detected changes in acceleration to the storage system 12.

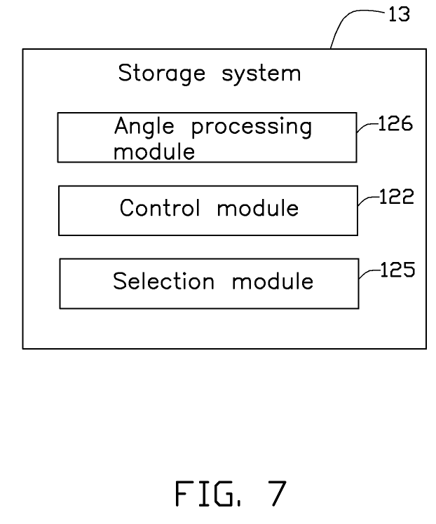

Referring to FIG. 7, the storage system 13 includes an angle processing module 126, a control module 122, and a selection module 125. The angle processing module 126 receives input from the accelerometer 11 to obtain an angle of inclination of the electronic device 100 relative to a datum plane. The control module 122 receives the measured angle of inclination of the electronic device 100 relative to the datum plane from the angle processing module 126, and outputs an angle control signal correspondingly. In a similar way, the selection system 2 selects one of the cameras 20 correspondingly.

In other embodiments, the datum plane may be another plane or multi-planes.

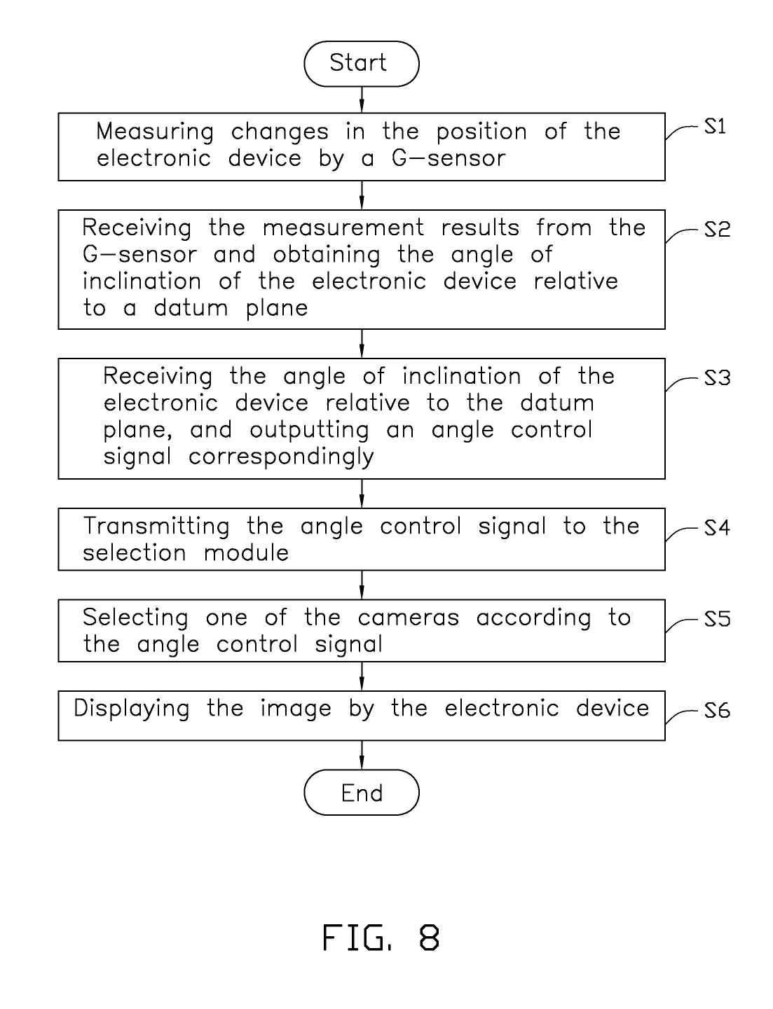

Referring to FIG. 8, a first exemplary embodiment of a selection method includes the following steps.

In step S1, the G-sensor 10 measures changes in the position of the electronic device 100.

In step S2, the angle processing module 120 receives the measurement results from the G-sensor 10 and obtains the angle of inclination of the electronic device 100 relative to the datum plane. It can be understood that the angle processing module 120 calculates and compares measurement from the G-sensor 10 corresponding to the position of the mobile phone 100 relative to the datum plane to obtain the angle of inclination of the electronic device 100 relative to the datum plane. For example, as shown in FIG. 3A, the angle between the electronic device 100 in the first state and the datum plane YOZ is 135°. As shown in FIG. 3B, the angle between the electronic device 100 in the second state and the datum plane YOZ is 0°. As shown in FIG. 3C, the angle between the electronic device 100 in the third state and the datum plane YOZ is 45°.

In step S3, the control module 122 receives the angle of inclination of the electronic device 100 relative to the datum plane from the angle processing module 120, and outputs an angle control signal correspondingly.

In step S4, the angle control signal is transmitted to the selection module 125.

In step S5, the selection module 125 selects one of the plurality of cameras 20 according to the angle control signal. For example, if the control module 122 outputs the first angle control signal, the selection module 125 selects the camera 20a. The camera 20a captures the image M1 as shown in FIG. 4.

In step S6, the image M1 captured by the camera 20a is transmitted to the electronic device 100 via the network unit 16. The electronic device 100 displays the image M1.

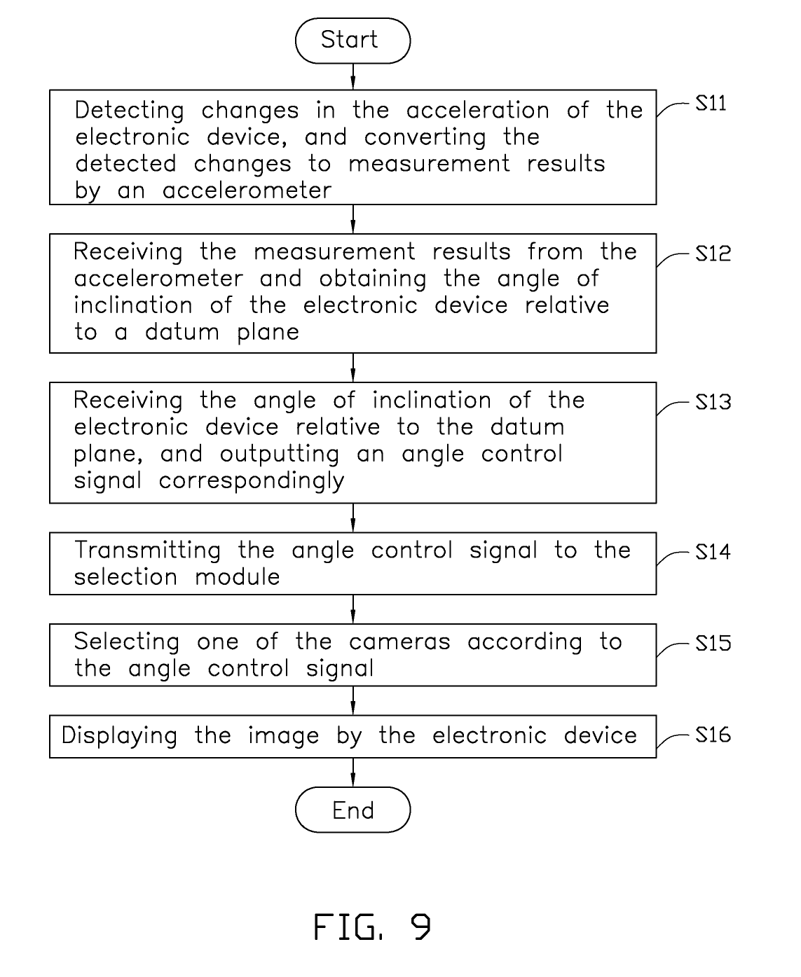

Referring to FIG. 9, a second exemplary embodiment of a selection method includes the following steps.

In step S11, the accelerometer 11 detects changes in the acceleration of the electronic device 100, and converts the detected changes to measurement results.

In step S12, the angle processing module 126 receives the measurement results from the accelerometer 11 and obtains the angle of inclination of the electronic device 100 relative to the datum plane. It can be understood that the angle processing module 126 calculates and compares voltages of the accelerometer 11 when the electronic device 100 is parallel with the datum plane and when the electronic device 100 is angled relative to the datum plane, to obtain the angle of inclination of the electronic device 100 relative to the datum plane.

In step S13, the control module 122 receives the angle of inclination of the electronic device 100 relative to the datum plane from the angle processing module 125, and outputs an angle control signal correspondingly.

In step S14, the angle control signal is transmitted to the selection module 125.

In step S15, the selection module 125 selects one of the plurality of cameras 20 according to the angle control signal.

In step S16, the image captured by one of the plurality of cameras 20 is transmitted to the electronic device 100 via the network unit 16. The electronic device 100 displays the image.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A selection system comprising:
a sensor mounted on an electronic device detecting changes in position of the electronic device and outputting measurement results correspondingly;
a plurality of cameras;
a processing unit; and
a storage system connected to the processing unit and storing one or more modules to be executed by the processing unit, wherein the one or more modules comprise:
an angle processing module to receive the measurement results and thereby obtain an angle of inclination of the electronic device relative to a datum plane;
a control module to receive the angle of inclination of the electronic device relative to the datum planes, and output an angle control signal correspondingly; and
a selection module to receive the angle control signal, and select one of the plurality of cameras according to the angle control signal, wherein the electronic device is operable to display images captured by the plurality of cameras.

2. The selection system of claim 1, further comprising a network unit, wherein the electronic device receives the images captured by the plurality of cameras via the network unit.

3. The selection system of claim 1, wherein the plurality of cameras forms an array camera system.

4. The selection system of claim 3, wherein the plurality of cameras is arranged circularly or on a curved surface.

5. A selection system comprising:
an accelerometer mounted on an electronic device to measure changes in acceleration of the electronic device and output measurement results correspondingly;
a processing unit;
a plurality of cameras; and
a storage system connected to the processing unit and storing one or more modules to be executed by the processing unit, wherein the one or more modules comprise:
an angle processing module to receive the measurement results and obtain an angle of inclination of the electronic device relative to a datum plane; and
a control module to receive the angle of inclination of the electronic device relative to the datum plane, and output an angle control signal correspondingly; and
a selection module to receive the angle control signal, and select one of the plurality of cameras according to the angle control signal, wherein the electronic device is operable to display images captured by the plurality of cameras.

6. The selection system of claim 5, further comprising a network unit, wherein the electronic device receives the images captured by the plurality of cameras via the network unit.

7. The selection system of claim 5, wherein the plurality of cameras form an array camera system

8. The selection system of claim 7, wherein the plurality of cameras are arranged in circularity, or on a curved surface.

9. A selection method comprising:
measuring changes in position of an electronic device by a sensor, and converting the changes to measurement results;
processing the measurement results from the sensor to obtain an angle of inclination of the electronic device relative to a datum plane correspondingly;
outputting an angle control signal according to the angle of inclination of the electronic device relative to the datum plane;
selecting one of the plurality of cameras according to the angle control signal; and
displaying images captured by the selected camera by the electronic device.

10. The selection method of claim 9, wherein the plurality of cameras forms an array camera system.

11. The selection method of claim 10, wherein the plurality of cameras is arranged circularly, or on a curved surface.
